(19) United States
(12) Patent Application Publication
(10) Pub. No.: US 2017/0023094 A1
(43) Pub. Date: Jan. 26, 2017

(54) HIGH PERFORMANCE TORSIONAL VIBRATION DAMPER

(71) Applicant: GM Global Technology Operations LLC, Detroit, MI (US)

(72) Inventor: SHUSHAN BAI, ANN ARBOR, MI (US)

(21) Appl. No.: 14/807,455

(22) Filed: Jul. 23, 2015

(51) Int. Cl. F16F 15/123

(52) U.S. Cl. CPC F16F 15/1234

(57) ABSTRACT

A torsional vibration damper for a motor vehicle includes an input member having a first race and a second race, the first and the second races each having an outer race surface. An output member is rotatably connected to the input member. At least two springs are positioned in each of the first race and the second race. A spring carrier is positioned between and contacts successive ones of the springs in each of the first and the second races, the spring carrier having a roller in rolling contact with the outer race surface of the first race and the second race. The spring carriers having the roller in contact with the outer race surface of the first race and the second race prevents any of the springs from directly contacting the outer race surfaces during rotation of the output member with respect to the input member.

### FIELD

The present disclosure relates to a powertrain torsional vibration damper or isolator, and more particularly to a powertrain torsional vibration damper having one or more spring carriers to prevent frictional contact between damper springs and an output member of the torsional vibration damper.

### BACKGROUND

The statements in this section merely provide background information related to the present disclosure and may or may not constitute prior art.

Motor vehicle engines produce torsional vibration that is undesirable to transmit through the powertrain and driveline to the motor vehicle. Typically, a torsional isolator or damper is used to isolate or reduce the torsional vibration transmitted from the engine to the transmission. The torsional vibration damper can be placed within a torque converter between a torque converter lock up clutch and an input member such as an input shaft of the transmission. Known torsional vibrational dampers use one or more springs to store energy and to isolate a direct vibration path between the engine and the transmission. Single, long arch springs are known which have a low spring constant and long travel. However, in certain powertrain configurations, particularly when the single long arch spring is used, the spring or springs of the torsional vibration damper outwardly deflect due to angular displacement of the damper, and may frictionally contact an outer race wall of the damper, causing undesirable changes in the spring damping rate, frictional wear of the spring or springs, and power loss of the torsional vibration damper.

Accordingly, there is room in the art for a torsional vibration damper that reduces frictional contact and wear of the damper springs.

### SUMMARY

The present disclosure provides an example of a torsional vibration damper for a motor vehicle, including an input member having at least one race, the race having an outer race surface. An output member is rotatably connected to the input member. At least two springs are positioned in the race. A spring carrier is positioned between and contacting successive ones of the at least two springs, the spring carrier having a roller in rolling contact with the outer race surface. The spring carrier having the roller in contact with the outer race surface prevents any of the at least two springs from directly contacting the outer race surface during rotation of the output member with respect to the input member.

In one example of the torsional vibration damper of the present disclosure, the spring carrier includes a center shaft rotatably supporting the roller to the spring carrier.

In yet another example of the torsional vibration damper of the present disclosure, the spring carrier includes a sprocket having opposed first and second sprocket walls, with the center shaft extending through the first and the second sprocket walls.

In yet another example of the torsional vibration damper of the present disclosure, a bearing is positioned within a cavity created between the first and the second sprocket walls, the bearing rotatably connecting the roller to the center shaft.

In yet another example of the torsional vibration damper of the present disclosure, the torque converter includes a torque converter lock up clutch.

In yet another example of the torsional vibration damper of the present disclosure, each of the at least two springs defines an arch shaped spring.

In yet another example of the torsional vibration damper of the present disclosure, each of the at least two springs defines a straight axis spring.

In yet another example of the torsional vibration damper of the present disclosure, the input member includes an input member tongue; and the output member includes an output member tongue overlapping the input member tongue in a non-rotated position of the torsional vibration damper.

In yet another example of the torsional vibration damper of the present disclosure, the input member tongue includes a cavity receiving a portion of the output member tongue, with one of the at least two springs contacting the input member tongue.

In yet another example of the torsional vibration damper of the present disclosure, the input member includes opposed first and second input member tongues; and the output member includes opposed first and second output member tongues, the first output member tongue overlapping the first input member tongue and the second output member tongue overlapping the second input member tongue in a non-rotated position of the torsional vibration damper.

In yet another example of the torsional vibration damper of the present disclosure, the at least one race includes first and second races, the first race located between a first contact face of the first input member tongue and a second contact face of the second input member tongue, and the second race located between a third contact face of the second input member tongue and a fourth contact face of the first input member tongue.

In yet another example of the torsional vibration damper of the present disclosure, each of the first and the second races includes an equal quantity of the at least one springs.

In yet another example of the torsional vibration damper of the present disclosure, an input member bushing fixed to the input member; an output member bushing fixed to the output member.

In yet another example of the torsional vibration damper of the present disclosure, a bearing set rotatably connects the output member bushing to the input member bushing permitting rotation of the input member with respect to the output member.

Further areas of applicability will become apparent from the description provided herein. It should be understood that the description and specific examples are intended for purposes of illustration only and are not intended to limit the scope of the present disclosure.

### DRAWINGS

The drawing described herein is for illustration purposes only and is not intended to limit the scope of the present disclosure in any way.

FIG. 1 is a front elevational view of a motor vehicle torsional vibration damper according to the principles of the present disclosure;

FIG. 2 is a cross sectional end elevational view of the torsional vibration damper taken at section 2 of FIG. 1;

FIG. 3 is a front elevational view of a spring carrier according to the principles of the present disclosure;

FIG. 4 is an end elevational view of the spring carrier of FIG. 3;

FIG. 5 is a cross sectional end elevational view taken at section 5 of FIG. 3;

FIG. 6 is a front elevational view of a motor vehicle torsional vibration damper according to another aspect of the present disclosure;

FIG. 7 is a cross sectional end elevational view of the torsional vibration damper taken at section 7 of FIG. 6;

FIG. 8 is a front elevational view of a motor vehicle torsional vibration damper according to a further aspect of the present disclosure; and

FIG. 9 is a cross sectional end elevational view of the torsional vibration damper taken at section 9 of FIG. 8.

### DETAILED DESCRIPTION

The following description is merely exemplary in nature and is not intended to limit the present disclosure, application, or uses.

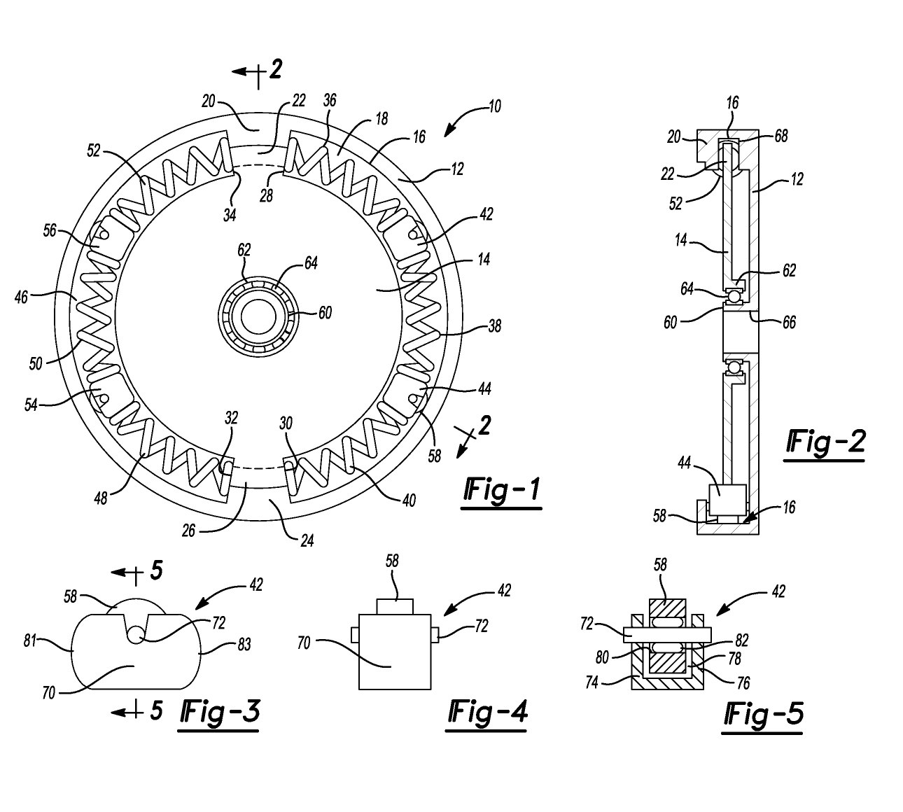

With reference to FIG. 1, a transmission-drive system for exemplary use in a torque converter of an automobile includes a torsional vibration damper 10 positioned within a torque converter (not shown), the torsional vibration isolator 10 used to isolate engine torque pulsations between an engine drive component and a transmission input member. The torsional vibration damper 10 includes an input member 12 such as an input shaft or input hub rotatably coupled to an output member 14 such as an output shaft or output hub. An outer race surface 16 of the input member 12 defines an outer extent of a first race 18.

The input member 12 includes a first input member tongue 20 which overlaps a first output member tongue 22 of the output member 14 which is shown in greater detail in reference to FIG. 2. Additional input and output member tongues can also be provided, which according to several aspects, includes a second input member tongue 24 which overlaps a second output member tongue 26. In the aspect shown, the second input and output member tongues 24, 26 are rotated or configured approximately 180 degrees away from the first input and output member tongues 20, 22, however this angular orientation is not limiting and other angular orientations can be used. The first race 18 is bounded between a first contact face 28 of the first input member tongue 20, and a second contact face 30 of the second input member tongue 24.

Positioned within the first race 18 are a plurality of springs and spring carriers, which include a spring 36, a spring 38, and a spring 40. Spring 36 directly contacts first contact face 28 and a face of a spring carrier 42. Spring 38 is positioned between and directly contacts spring carrier 42 and a spring carrier 58. Spring 40 is positioned between and directly contacts spring carrier 44 and the second contact face 32.

The outer race surface 16 of the input member 12 also defines an outer extent of a second race 46. The second race 46 is bounded between a third contact face 32 of the second input member tongue 24, and a fourth contact face 34 of the first input member tongue 20. Positioned within the second race 46 in a mirror image of the first race 18 are also a plurality of springs and spring carriers, which include a spring 48, a spring 50, and a spring 52. Spring 48 directly contacts third contact face 32 and a face of a spring carrier 54. Spring 50 is positioned between and directly contacts spring carrier 54 and a spring carrier 56. Spring 52 is positioned between and directly contacts spring carrier 56 and the fourth contact face 34. According to several aspects, each of the springs of the torsional vibration damper 10 are arch shaped. According to other aspects, each of the first race 18 and the second race 46 include an equal quantity of the springs.

Rotation of the input member 12 with respect to the output member 14 due to continuous engine torque pulsations compresses or loads the various springs, storing energy in the springs, thereby damping the effect of the engine torque pulsations. This energy is released between engine torque pulsations by opposite rotation of the input member 12 with respect to the output member 14.

During compression of the various damper springs, to minimize the potential of frictional contact between the springs and the outer race surface 16 of the input member 12, each of the spring carriers 42, 44, 54, 56 includes a roller 58 which rolls along the outer race surface 16 as the spring carriers 42, 44, 54, 56 are displaced. The use of rollers 58, combined with the reduced length of each of the springs 36, 38, 40, 48, 50, 52 compared to a spring length of a continuous arch spring positioned in each of the first race 18 and second race 46 as known in the art, reduces the outward deflection of the springs toward the outer race surface 16, substantially preventing any of the springs 36, 38, 40, 48, 50, 52 from directly contacting the outer race surface 16. The use of rollers 58 with each of the spring carriers 42, 44, 54, 56 also limits frictional contact at the outer race surface to a rolling friction as the spring carriers 42, 44, 54, 56 are angularly displaced within the first race 18 and the second race 46.

With continued reference to FIG. 1, and with reference to FIG. 2, the input member 12 is rotatably connected to the output member 14 using an input member bushing 60 positioned within an output member bushing 62, the two bushings rotatably separated using a bearing set 64. The input member bushing 60 provides a bushing sleeve 66 for mounting the torsional vibration damper 10 on a shaft of the powertrain. As more clearly depicted in FIG. 2, the first input member tongue 20 includes a cavity 68 wherein a portion of the output member 14 is received, permitting angular rotation between the input member 12 and the output member 14 while retaining rotating engagement between the input member 12 and the output member 14.

Referring to FIGS. 3-5 and again to FIGS. 1 and 2, each of the spring carriers 42, 44, 54, 56 are substantially identical, therefore the following discussion of spring carrier 42 applies equally to each of the spring carriers. Spring carrier 42 includes a body or sprocket 70, which receives the roller 58 and rotatably supports the roller 58 on a center shaft 72. The center shaft 72 can be fixed to and extends beyond each of opposed first and second sprocket walls 74, 76 of the sprocket 70. A cavity 78 is thereby defined between the first and second sprocket walls 74, 76 which rotatably receives the roller 58. A shaft aperture 80 of the roller 58 provides space for a shaft bearing 82, the roller 58 being rotatably mounted to the center shaft 72 using the shaft bearing 82. Opposed end faces 81, 83 of the sprocket 70 define faces contacted by one or more of the damper springs 36, 38, 40, 48, 50, 52. The end faces 81, 83 are oriented 90 degrees with respect to the center shaft 72.

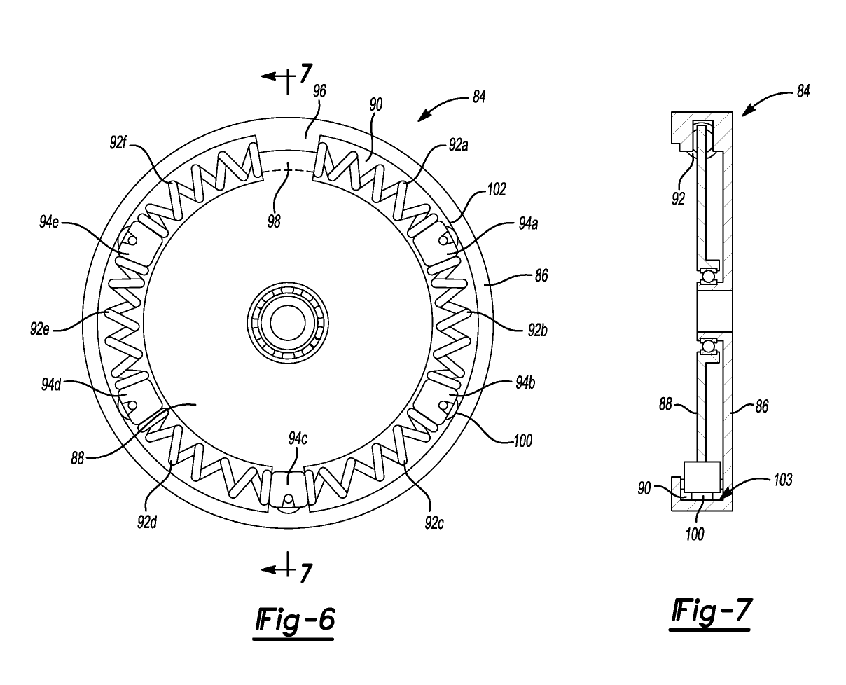

Referring to FIGS. 6 and 7, and again to FIGS. 1-4, according to additional aspects of the disclosure, a torsional vibration damper 84 is similar to torsional vibration damper 10, therefore only the differences will be discussed further herein. Torsional vibration damper 84 includes an input member 86, and an output member 88, with only a single or extended race 90 created in the input member 86. Multiple arch springs of the same design, designated as springs 92a, 92b, 92c, 92d, 92e, and 92f are positioned within the extended race 90. Successive ones of the springs 92a, 92b, 92c, 92d, 92e, 92f are separated using spring carriers 94, such as spring carriers 94a, 94b, 94c, 94d, 94e, which are substantially identical to spring carriers 42, 44, 54, 56 previously discussed. Rollers 100 of each of the spring carriers 94a, 94b, 94c, 94d, 94e rotate when in moving contact with an outer race surface 102 of extended race 90, as the input member 86 and the output member 88 rotate with respect to each other.

The springs 92a, 92b, 92c, 92d, 92e, 92f are compressed by rotation between a single input member tongue 96 and a single output member tongue 98. Torsional vibration damper 84 provides damping functionality similar to known vibration dampers that include a single arch spring positioned in an extended race, however, the use of multiple spring carriers 94a, 94b, 94c, 94d, 94e prevent the springs 92a, 92b, 92c, 92d, 92e, 92f of torsional vibration damper 84 from directly contacting an outer race surface 103 of extended race 90.

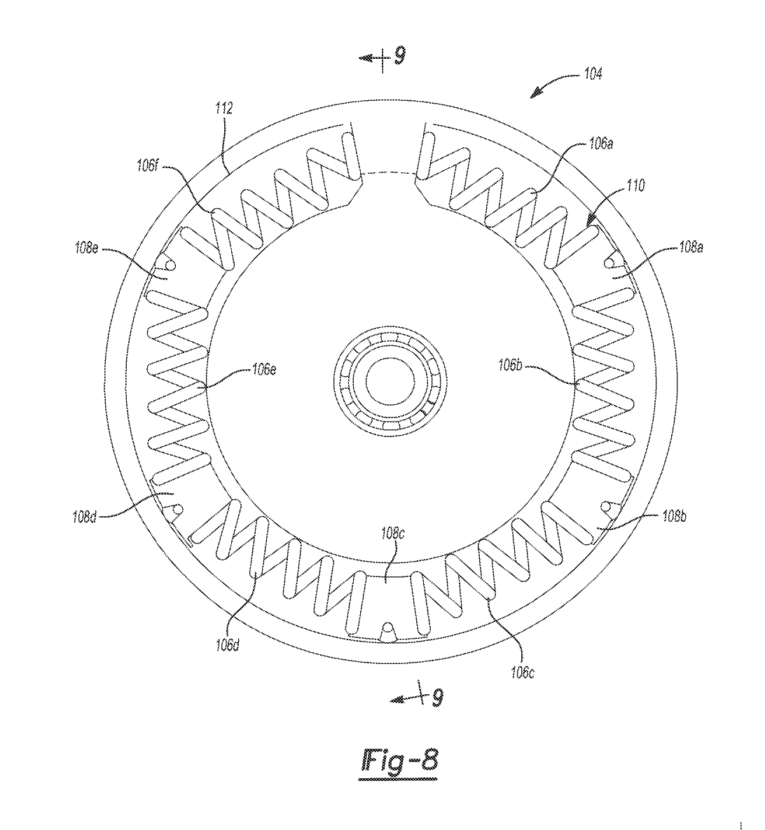

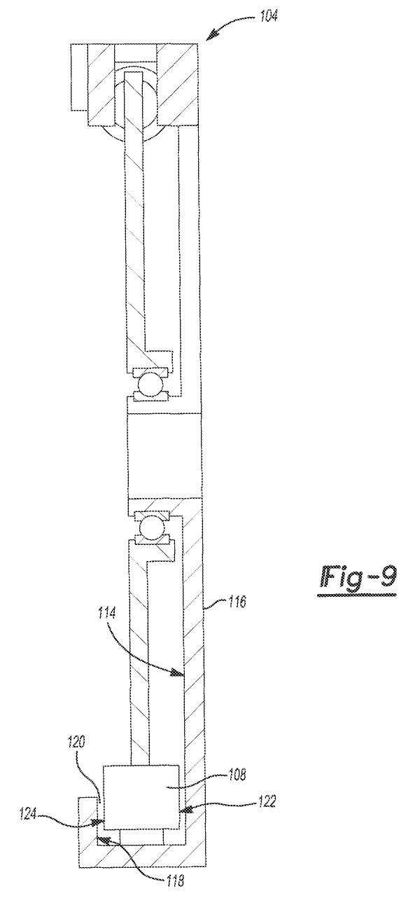

Referring to FIGS. 8 and 9, and again to FIGS. 1-7, according to additional aspects of the disclosure, a torsional vibration damper 104 is similar to torsional vibration dampers 10 and 84, therefore only the differences will be discussed further herein. In lieu of the arch springs used in torsional vibration dampers 10 and 84, torsional vibration damper 104 includes multiple straight axis springs 106, which do not include an arch shaped body matching a curvature of the input member race. Successive ones of the straight axis springs 106a, 106b, 106c, 106d, 106e, 106f are separated using spring carriers 108, such as spring carriers 108a, 108b, 108c, 108d, 108e. Spring carriers 108 may be substantially identical to spring carriers 42, 44, 54, 56 previously discussed, or they may include opposed carrier end faces 110 that are angularly modified with respect to end faces 81, 83 discussed in reference to FIG. 3 to accommodate differently angled end coils of the straight springs 106. The use of straight springs, such as straight springs 106a, 106b, 106c, 106d, 106e, 106f provides further nominal clearance between the bodies or spring coils of the straight springs 106 and an outer race surface 112 of the input race of torsional vibration damper 104 compared to comparably sized arch springs.

With specific reference to FIG. 9, a race 114 defined by the outer race surface 112 of an input member 116 of torsional vibration damper 104 is also limited by an opposed inner wall 118. A center shaft 120 of the spring carrier 108 includes a first member end 122 and an opposed second member end 124. According to several aspects of the disclosure, the first member end 122 can have a sliding fit with respect to the outer race surface 112 and a sliding fit with respect to the inner wall 118 to help center the spring carrier 108 as it travels within the race 114.

In addition, it should be appreciated that the torsional vibrational isolator 10 may have other configurations, such as having springs in parallel, without departing from the scope of the present disclosure.

The description of the invention is merely exemplary in nature and variations that do not depart from the general gist of the invention are intended to be within the scope of the invention. Such variations are not to be regarded as a departure from the spirit and scope of the invention.

1. A torsional vibration damper for a motor vehicle, comprising:
an input member having at least one race, the race having an outer race surface;
an output member rotatably connected to the input member;
at least two springs positioned in the race; and
a spring carrier positioned between and contacting successive ones of the at least two springs, the spring carrier having a roller in rolling contact with the outer race surface;
each spring carrier including a sprocket having opposed end faces of the sprocket defining faces contacted by two of the springs, the end faces oriented approximately 90 degrees with respect to a center shaft rotatably supporting the roller to the sprocket;
wherein the spring carrier having the roller in contact with the outer race surface prevents any of the at least two springs from directly contacting the outer race surface during rotation of the output member with respect to the input member.

2. (canceled)

3. The torsional vibration damper for a motor vehicle of claim 1, wherein the spring carrier includes a sprocket having opposed first and second sprocket walls, with the center shaft extending through the first and the second sprocket walls.

4. The torsional vibration damper for a motor vehicle of claim 3, further including a bearing positioned within a cavity created between the first and the second sprocket walls, the bearing rotatably connecting the roller to the center shaft.

5. The torsional vibration damper for a motor vehicle of claim 3, wherein the center shaft is fixed to and extends beyond each of opposed first and second sprocket walls of a sprocket of the spring carrier, thereby defining a cavity between the first sprocket wall and the second sprocket wall, the cavity rotatably receiving the roller; and a shaft aperture of the roller receiving a shaft bearing, the roller being rotatably mounted to the center shaft using the shaft bearing.

6. The torsional vibration damper for a motor vehicle of claim 1, wherein each of the at least two springs defines an arch shaped spring.

7. The torsional vibration damper for a motor vehicle of claim 1, wherein each of the at least two springs defines a straight axis spring.

8. The torsional vibration damper for a motor vehicle of claim 1, wherein:
the input member includes an input member tongue; and
the output member includes an output member tongue overlapping the input member tongue in a non-rotated position of the torsional vibration damper.

9. The torsional vibration damper for a motor vehicle of claim 8, wherein the input member tongue includes a cavity receiving a portion of the output member tongue, with one of the at least two springs contacting the input member tongue.

10. The torsional vibration damper for a motor vehicle of claim 1, wherein:
the input member includes opposed first and second input member tongues; and
the output member includes opposed first and second output member tongues, the first output member tongue overlapping the first input member tongue and the second output member tongue overlapping the second input member tongue in a non-rotated position of the torsional vibration damper.

11. The torsional vibration damper for a motor vehicle of claim 10, wherein the at least one race includes first and second races, the first race located between a first contact face of the first input member tongue and a second contact face of the second input member tongue, and the second race located between a third contact face of the second input member tongue and a fourth contact face of the first input member tongue.

12. The torsional vibration damper for a motor vehicle of claim 11, wherein each of the first and the second races includes an equal quantity of the at least two springs.

13. The torsional vibration damper for a motor vehicle of claim 1, further including:
an input member bushing fixed to the input member;
an output member bushing fixed to the output member; and
a bearing set rotatably connecting the output member bushing to the input member bushing permitting rotation of the input member with respect to the output member.

14. A torsional vibration damper for a motor vehicle, comprising:
an input member having a first race and a second race, the first and the second races each having an outer race surface;
an output member rotatably connected to the input member;
at least two springs positioned in each of the first race and the second race; and
multiple spring carriers, with individual ones of the spring carriers positioned between and contacting successive ones of the at least two springs in each of the first race and the second race, the spring carriers each having a roller in rolling contact with the outer race surface of the first race and the second race;
each of the spring carriers including a sprocket having opposed end faces of the sprocket defining faces contacted by two of the springs, the end faces oriented approximately 90 degrees with respect to a center shaft rotatably supporting the roller to the sprocket;
wherein the spring carriers having the roller in contact with the outer race surface of the first race and the second race prevents any of the at least two springs from directly contacting the outer race surfaces during rotation of the output member with respect to the input member.

15. The torsional vibration damper for a motor vehicle of claim 14, further including an inner wall of the races of the input member opposed to the outer race surface.

16. The torsional vibration damper for a motor vehicle of claim 15, wherein a center shaft of the spring carrier includes a first shaft end and an opposed second shaft end.

17. The torsional vibration damper for a motor vehicle of claim 16, wherein the first shaft end is positioned for a sliding fit with respect to the outer race surface.

18. The torsional vibration damper for a motor vehicle of claim 17, wherein the second shaft end is positioned for a sliding fit with respect to the inner wall of the races to center each spring carrier during travel within one of the races.

19. A motor vehicle comprising:
a torsional vibration damper including:
an input member having at least one race, the race having an outer race surface;
an output member rotatably connected to the input member;
at least two straight axis springs positioned in the race including a straight shaped body differing from a curvature of the input member race; and
a spring carrier positioned between and contacting successive ones of the at least two straight axis springs, the spring carrier having a center shaft rotatably supporting a roller to the spring carrier, and a roller in rolling contact with the outer race surface;
wherein the spring carrier having the roller in contact with the outer race surface prevents any of the at least two straight axis springs from directly contacting the outer race surface during rotation of the output member with respect to the input member.

20. The motor vehicle of claim 19, wherein the spring carrier includes:
a sprocket having opposed first and second sprocket walls, with the center shaft extending through the first and the second sprocket walls; and
a bearing positioned within a cavity created between the first and the second sprocket walls, the bearing rotatably connecting the roller to the center shaft.
